(19) United States
(12) Patent Application Publication
(10) Pub. No.: US 2009/0172943 A1
(43) Pub. Date: Jul. 9, 2009

(54) Process for finishing internal combustion engine cylinders using cold working

(76) Inventor: August Jameson Rolling, (US)

Correspondence Address: Dr. August Jameson Rolling, 2423 Cinnabar Road, Colorado Springs, CO, 80921, US

(21) Appl. No.: 11/970,474

(22) Filed: Jan. 7, 2008

(51) Int. Cl. B23P 17/00

(52) U.S. Cl. 29/888.06; 29/888.061

(57) ABSTRACT

A new method for internal combustion engine cylinder finishing is proposed. Techniques for engine bore out, cylinder finish, and metal sleeve replacement have been developed for internal combustion engines. Separately, mandrel pull-through cold-working methods for fatigue life improvement have existed for holes with cracks. However, despite the decades old technology, mandrel pull-through cold-working has not been applied as the critical step in engine cylinder finishing. The first filing for the invention was provisional patent application 60883908 for “Cold-working application in combustion engines” submitted by the inventor on 8 Jan. 2007. This invention provides multiple techniques for applying mandrel pull through technology to cylinders that experience the hot, high cycle environment found in internal combustion engine cylinders. The method of employing cold-working as a critical step in engine cylinder finishing forms the basis for all claims listed.

Cross Reference to related applications (if any). (Related applications may be listed on an application data sheet, either instead of or together with being listed in the specification.)

Cylinder Boring: U.S. Pat. No. 5,848,778 (1995)

Cylinder Finish: U.S. Pat. No. 4,724,819 (1987)

Metal Sleeve: U.S. Pat. No. 5,497,693 (1994) U.S. Pat. No. 5,666,725 (1995) U.S. Pat. No. 7,165,597 (2004)

Cold-work Mandrel Pull-Through: U.S. Pat. No. 3,892,121 (1973) U.S. Pat. No. 4,187,708 (1977) U.S. Pat. No. 4,934,170 (1989) U.S. Pat. No. 5,127,254 (1991) U.S. Pat. No. 5,433,100 (1993)

Cold-Working application in combustion engines: Provisional Patent 60883908, Inventor, August J. Rolling

Statement of federally sponsored research/development (if any).

NONE

Reference to a “Sequence Listing,” a table, or a computer program listing appendix submitted on a compact disc and an incorporation by reference of the material on the compact disc.

NONE

### BACKGROUND OF THE INVENTION

This invention relates to the finishing method for internal combustion engine new and/or restored cylinders. Current manufacturing and rebuild techniques fall short of providing the advantages of the method proposed by this new process.

Conventional piston driven internal combustion engines have individual cylinders to house each piston. These cylinders wear over time and may become out of round. In other cases, due to increased performance desires, the cylinder interior diameter can be enlarged. For each of these rebuild cases, the inside diameter of the cylindrical housing is commonly bored out. The housing is cut cutting tip, cleaned with a hone, and often smoothed with a deburring tool. At this point, machine shops have several methods available prior to reassembly. These include using oversized pistons or inserting a sleeve to regain the original interior diameter. When a sleeve is used, the engine block can be heated and the sleeve place in liquid nitrogen just prior to inserting in the cylinder to achieve an interference fit. In other cases, a slip fit sleeve is used. Either technique leaves much to be desired in terms of safety, expense, and overall performance.

This invention provides several advantages for i) new, ii) metal sleeve rebuilt, or iii) no sleeve rebuilt cylinders. This invention adds a cold-working step to the finishing process. By cold-working the interior walls of a sleeved or sleeveless cylinder, the fatigue life is increased. Other advantage gains are achieved depending on the application. The new cylinder may be purposely manufactured to allow for a sleeve, as is often the case for diesel engines. So there are two cases to consider: without metal sleeve insert and with metal sleeve insert.

The sleeveless benefits of the present invention include increased fatigue life by pre-straining the interior cylinder walls. Additionally, the interior diameter will be slightly oversized, which in combination with an oversized piston, could provide increased performance. The drawback to this application is the additional time and expense of tooling. Still, the advantages may outweigh the costs through increased engine life.

The real advantage and recommended best-mode-application of the invention occurs when using a metal sleeve. For an out-of-round cylinder rebuild, if the bore diameter is too large, conventional fit techniques may be required for metal sleeve insert. At this point, the advantages of the invention are the same as for a non-sleeve retrofit. However, for slight out-of-round, or new manufacture, a thin-wall metal sleeve can be used. This allows for a slip-fit design that will become interference-fit after cold-working. This method provides all of the advantages previously discussed. Additionally, using a thin-wall metal sleeve eliminates the expense and safety concerns associated with heating the block and keeping liquid nitrogen on-site while still providing an overall interference fit product.

The user of this new process can choose from the several cold-work techniques available. It is recommended that a mandrel-pull-through technique provides the most promise, since its design application is for holes which can be adapted to the cylindrical application proposed here. Mandrel-pull-through techniques for cold-working can be traced back to U.S. Pat. No. 3,892,121 filed in 1973. Since then, many variations have been developed as improvements for cold-working holed. However, each of these techniques have only been applied to piece-parts experiencing fatigue cracking. An application in a hot, high-cycle environment has not previously been considered. Despite the long period that this type of technology has been available, this present invention is the first instance where mandrel-pull-through cold-working has been considered for internal combustion engine cylinders, proving its non-obvious nature. This invention does not claim a new cold-working technique or design new tooling. Instead, it introduces a new process for internal combustion engine cylinder manufacture or rebuild that takes advantage of cold-working products from other industries.

### BRIEF SUMMARY OF THE INVENTION

All of the advantages described above come from a new process in internal combustion engine cylinder manufacture or rebuild. This invention provides the additional step of cold-working the interior wall of a sleeveless or metal-sleeved cylinder prior to (re)assembly.

In greater specificity, the new process depends on the technique selected:

1) For Non-Sleeve Application:

Cylinder preparation must be designed to account for slight increases in interior diameter due to cold-working. This increase in interior diameter is dependent on the thickness of material and diameter size, but should be on the order of 5% of the pre-worked diameter for most internal combustion cylinders. Obviously it produces larger absolute changes for smaller diameters and smaller absolute changes for larger diameters. This will require oversized piston(s) for rebuilds or smaller interior diameter pre-worked cylinders for new manufacture.

2) For Sleeve Application:

In addition to cylinder sizing for slip or interference-fit applications, careful metal sleeve design must be applied. Rather than step through each process individually here, this effort is carried through in the claims section.

Several techniques are claimed and described in the claims section. These depend on the specific case and desired effect.

### BRIEF DESCRIPTION OF THE SEVERAL VIEWS OF THE DRAWING (IF ANY)

NONE.

### DETAILED DESCRIPTION OF THE INVENTION

A new process for finishing internal combustion engines includes a critical cold-working step. This additional step increases fatigue life of the engine and provides several other advantages described in the background section. This technique applies to both new and rebuilt engines and follows the cylinder clean up step. At this point, a sleeveless and with-metal sleeve approach can be applied.

As shown in the cross-references, cylinder boring, cylinder finishing, and metal sleeve manufacture have each been addressed for internal combustion engines. However, no current internal combustion engine cylinder finishing process applies mandrel pull-through cold-working, despite the method's decades old history.

The preferred method is to use a thin-walled metal sleeve that will allow for cold-working the metal sleeve interior and allow for an interference fit of the sleeve with the cylinder. All process steps are listed in the claims section of this patent.

1. A preferred method of finishing an internal combustion engine cylinder for newly manufactured internal combustion engines without metal sleeves, comprising the following steps:
a) Design cylinder hole for interior diameter expansion due to cold-working. This is to ensure proper fit of normal piston after cold-working;
b) Apply selected cold-working technique;
c) Complete engine assembly.

2. A method of finishing an internal combustion engine cylinder for newly manufactured internal combustion engines with slip-fit metal sleeve comprising the following steps:
a) Design metal sleeve where i) metal sleeve's post-cold-worked interior diameter meets piston requirements and ii) of sufficient thickness to produce zero plastic deformation at outer diameter of sleeve;
b) Design cylinder hole for slip fit of outer diameter of metal sleeve;
c) Insert metal sleeve into cylinder;
d) Apply selected cold-working technique;
e) Complete engine assembly.

3. A method of finishing an internal combustion engine cylinder for newly manufactured internal combustion engines with interference-fit metal sleeve comprising the following steps:
a) Design metal sleeve where i) metal sleeve's post-cold-worked interior diameter meets piston requirements and ii) of thickness to allow desired deformation at outer diameter of sleeve;
b) Design cylinder hole for slip fit of outer diameter of pre-worked metal sleeve;
c) Insert metal sleeve into cylinder;
d) Apply selected cold-working technique (the action of cold-working produces the interference fit by straining the metal sleeve);
e) Complete engine assembly.

4. A method of finishing an internal combustion engine cylinder for engine rebuild without metal sleeve:
a) Design bore-out diameter to account for expansion due to cold working. This is to ensure proper selection/design of oversized piston after cold-working;
b) Apply selected cold-working technique;
c) Complete engine assembly.

5. A method of finishing an internal combustion engine cylinder for engine rebuild with metal sleeve with slip-fit:
a) Design metal sleeve where i) metal sleeve's post-cold worked interior diameter meets piston requirements (oversized or normal) and ii) of sufficient thickness to produce zero plastic deformation at outer diameter of sleeve;
b) Design bore-out diameter to allow for slip fit of outer diameter of metal sleeve;
c) Insert metal sleeve into cylinder;
d) Apply selected cold-working technique;
e) Complete engine assembly.

6. The preferred method of finishing an internal combustion engine cylinder for engine rebuild with metal sleeve with interference-fit:
a) Design metal sleeve where i) metal sleeve's post-cold worked interior diameter meets piston requirements (oversized or normal) and ii) of thickness to allow desired deformation at outer diameter of sleeve;
b) Design bore-out diameter to allow for slip fit of outer diameter of metal sleeve;
c) Insert metal sleeve into cylinder;
d) Apply selected cold-working technique;
e) Complete engine assembly.

7. Any combined techniques that incorporate cold-working as part of the finish process for either sleeved or unsleeved internal combustion engine cylinders are claimed as falling under this invention.
